(19) United States
(12) Patent Application Publication
(10) Pub. No.: US 2009/0111291 A1
(43) Pub. Date: Apr. 30, 2009

(54) Information storage card holding structure and electrical device using the same

(75) Inventor: Jun Wan, Suzhou (CN)

Correspondence Address: BACON & THOMAS, PLLC, 625 SLATERS LANE, FOURTH FLOOR, ALEXANDRIA, VA, 22314-1176, US

(73) Assignee: BenQ Corporation, TAIPEI (TW)

(21) Appl. No.: 12/285,639

(22) Filed: Oct. 10, 2008

(30) Foreign Application Priority Data
Oct. 26, 2007 (TW) 96140299

(51) Int. Cl. H01R 13/631; H01R 12/02

(52) U.S. Cl. 439/68; 439/325

(57) ABSTRACT

An information storage card holding structure and an electric device using the same are provided. The electric device includes a circuit board and an information storage card holding structure. The holding structure, making an information storage card selectively electrically connected to several metallic points placed on a surface of the circuit board, includes a containing element, a crutch, a protrusion and a slide. The containing element contains the information storage card. The crutch supports the containing element. The slide is coupled to the protrusion. The protrusion is disposed on one of the containing element and the crutch. The slide is disposed on the other of the two. When the protrusion is located on a first regain track, the information storage card has a first gap to the surface. When the protrusion is located on a second regain track, the information storage card has a second gap to the surface.

This application claims the benefit of Taiwan application Serial No. 96140299, filed Oct. 26, 2007, the subject matter of which is incorporated herein by reference.

### BACKGROUND OF THE INVENTION

1. Field of the Invention

The invention relates in general to an information storage card holding structure and an electric device using the same, and more particularly to an information storage card holding structure installed by sliding and an electric device using the same.

2. Description of the Related Art

Along with the advance in science and technology, various electric devices are provided. One of these electric devices is operated via an information storage card, and examples of such electric device include a cellular phone operated via a subscriber identity module (SIM) card and a digital camera operated via a flash memory card. The information storage card, which can be used in different electric devices, is disposed in an electric device by way of electrical connection.

The information storage card is normally installed in an electric device by sliding so as to be electrically connected to the metallic points. Referring to FIG. 1, an installation diagram of a conventional information storage card is shown. The contact base 10 of the circuit board of the electric device includes a plurality of metallic points 11. The metallic points 11 have elasticity in a direction Z, and the information storage card 30 is electrically connected to the electric device by compressing the metallic points 11 in the direction Z.

Furthermore, before the metallic points 11 are electrically connected to the information storage card 30, the gap between the apex of the metallic points 11 and a bottom surface 15 of the contact base 10 is denoted by H10. During installing the information storage card 30, the user provides an external force F to move the information storage card 30 in a direction D. After the information storage card 30 is installed, the metallic points 11 are compressed.

The external force F is decomposed into two component forces F10 and F20, wherein the component force F10 is parallel to the direction D, and the component force F20 is parallel to the direction Z. During installing the information storage card 30, when the component force F20 is too small to compress the metallic points 11 in the Z direction, the metallic points 11 will receive the component force F10 in the D direction. As the metallic points 11 of the contact point base 10 cannot be shifted in the direction D, the component force F10 may cause damage to the metallic points 11. To the worse, one end of the metallic points 11 may be curled up or the contact base 10 may even be damaged, hence decreasing the reliability and lifespan of the electric device.

Besides, during installing the information storage card 30, when the component force F20 is not sufficient, the metallic points 11 may also impede the advance of the information storage card 30 and the information storage card 30 may even be dead-locked and cannot be installed smoothly. Thus, how to protect the metallic points and avoid the information storage card 30 being dead-locked during the installation has become an imminent issue to be resolved.

### SUMMARY OF THE INVENTION

The invention is directed to an information storage card holding structure and an electric device using the same. With the disposition of a protrusion and a slide, the information storage card will not be dead-locked and the metallic points of the electric device will not be damaged by an external force during installing an information storage card, wherein the protrusion is coupled to the slide by sliding and the slide has two regain tracks.

According to a first aspect of the present invention, an information storage card holding structure is provided. The information storage card holding structure is for making an information storage card selectively electrically connected to several metallic points that are placed on a surface of a circuit board. The holding structure includes a containing element, a crutch, a protrusion, and a slide. The containing element is for containing the information storage card. The crutch is for supporting the containing element. The slide is coupled to the protrusion. The protrusion is disposed on one of the containing element and the crutch, and the slide is disposed on the other of the two elements. The slide is for guiding the containing element to move relatively to the crutch. The slide has a first regain track and a second regain track. When the protrusion is located on the first regain track, the information storage card has a first gap to the surface. When the protrusion is located on the second regain track, the information storage card has a second gap to the surface and is electrically connected to the metallic points. The second gap is smaller than the first gap.

According to a second aspect of the present invention, an electric device including a circuit board and an information storage card holding structure is provided. The circuit board has a surface. The information storage card holding structure includes a containing element, a crutch, a protrusion and a slide. The information storage card holding structure is for making an information storage card selectively electrically connected to several metallic points that are placed on a surface of the circuit board. The containing element is for containing the information storage card. The crutch is for supporting the containing element. The slide is coupled to the protrusion. The protrusion is disposed on one of the containing element and the crutch, and the slide is disposed on the other of the two elements. The slide is for guiding the containing element to move relatively to the crutch. The slide has a first regain track and a second regain track. When the protrusion is located on the first regain track, the information storage card has a first gap to the surface. When the protrusion is located on the second regain track, the information storage card has a second gap to the surface and is electrically connected to the metallic points. The second gap is smaller than the first gap.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows an installation diagram of a conventional information storage card;

FIG. 2 shows a perspective of an electric device according to a first embodiment of the invention;

FIG. 3 shows a partial explosion diagram of the region 2 of FIG. 2;

FIGS. 4A and 4B show two perspectives of the first protrusion of FIG. 3 being located on a first regain track;

FIG. 4C shows a cross-sectional view of the information storage card and metallic points of FIG. 4A along a cross-sectional line 4A-4A′;

FIGS. 5A and 5B show two perspective of the first protrusion of FIG. 3 being located on a second regain track;

FIG. 5C shows a cross-sectional view of the information storage card and metallic points of FIG. 5A along a cross-sectional line 5A-5A′;

FIG. 6A shows a perspective of a first protrusion being located on a second regain track according to a second embodiment of the invention;

FIG. 6B shows a cross-sectional view of FIG. 6A;

FIG. 7A shows a perspective of a first protrusion being located on a second regain track according to a third embodiment of the invention;

FIG. 7B shows a cross-sectional view of FIG. 7A;

FIG. 8A shows a perspective of a first protrusion being located on a first regain track according to a fourth embodiment of the invention;

FIG. 8B shows a cross-sectional view of FIG. 8A;

FIG. 9A shows a perspective of a first protrusion being located on a second regain track according to a fourth embodiment of the invention; and

FIG. 9B shows a cross-sectional view of FIG. 9A.

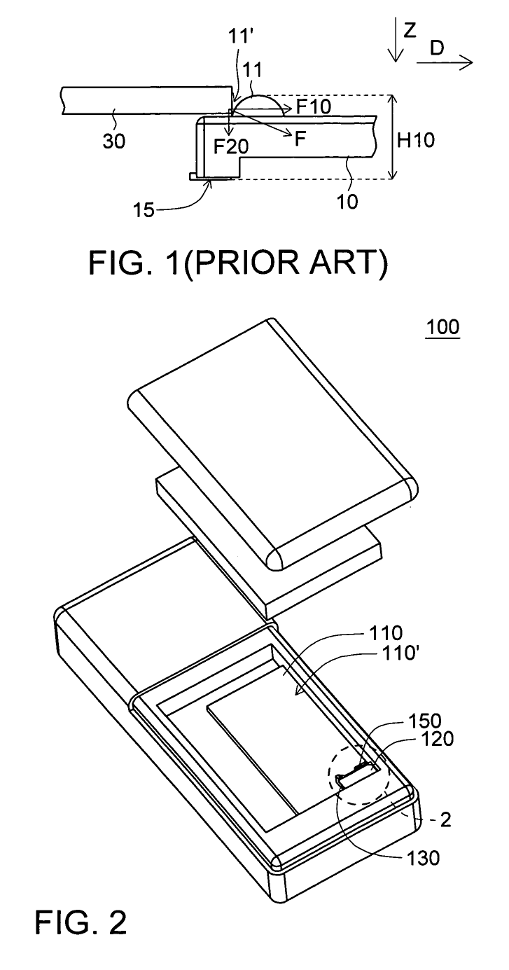

### DETAILED DESCRIPTION OF THE INVENTION

### First Embodiment

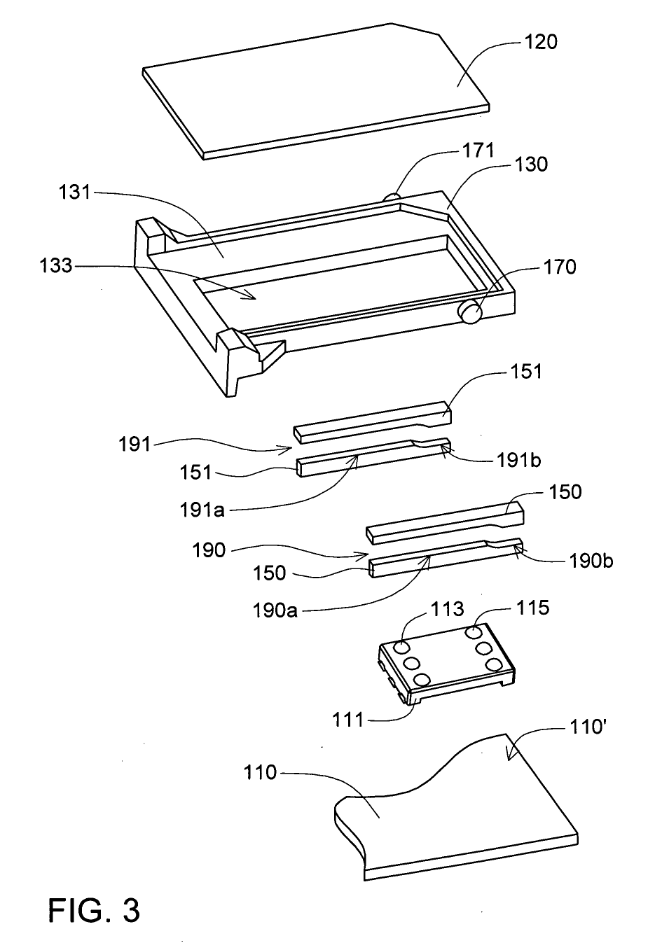

Referring to FIG. 2 and FIG. 3. FIG. 2 shows a perspective of an electric device according to a first embodiment of the invention. FIG. 3 shows a partial explosion diagram of the region 2 of FIG. 2. The electric device 100 includes a circuit board 110 and an information storage card holding structure. The circuit board 110 has a surface 110′. The information storage card holding structure includes a containing element 130, a crutch 150, a first protrusion 170 and a first slide 190. The information storage card holding structure is for making an information storage card 120 selectively electrically connected to several metallic points. The metallic points are two metallic points 113 and 115 for example. The metallic points 113 and 115 are placed on the surface 110′ of the circuit board 110 via a contact base 111.

The containing element 130 is for containing the information storage card 120, the crutch 150 is for supporting the containing element 130, and the first slide 190 is coupled to the first protrusion 170. The first protrusion 170 is disposed on one of the containing element 130 and the crutch 150, and the first slide 190 is disposed on the other of the two elements. In the present embodiment of the invention, the first protrusion 170 is disposed on the containing element 130 and the first slide 190 is disposed on the crutch 150. The first slide 190 is for guiding the containing element 130 to move relatively to the crutch 150. The first slide 190 has a first regain track 190a and a second regain track 190b. When the first protrusion 170 is located on the first regain track 190a, the information storage card 120 has a first gap to the surface 110′. When the first protrusion 170 is located on the second regain track 190b, the information storage card 120 has a second gap to the surface 110′, and the information storage card 120 is electrically connected to the metallic points 113 and 115. The second gap is smaller than the first gap.

Preferably, the metallic points 113 and 115 are both metallic elastic pieces. The containing element 130 is a containing platform 131 whose bottom has an opening 133 via which the information storage card 120 is selectively electrically connected to the metallic points 113 and 115. When the first protrusion 170 is located on the first regain track 190a, the information storage card 120 does not contact the metallic points 113 and 115.

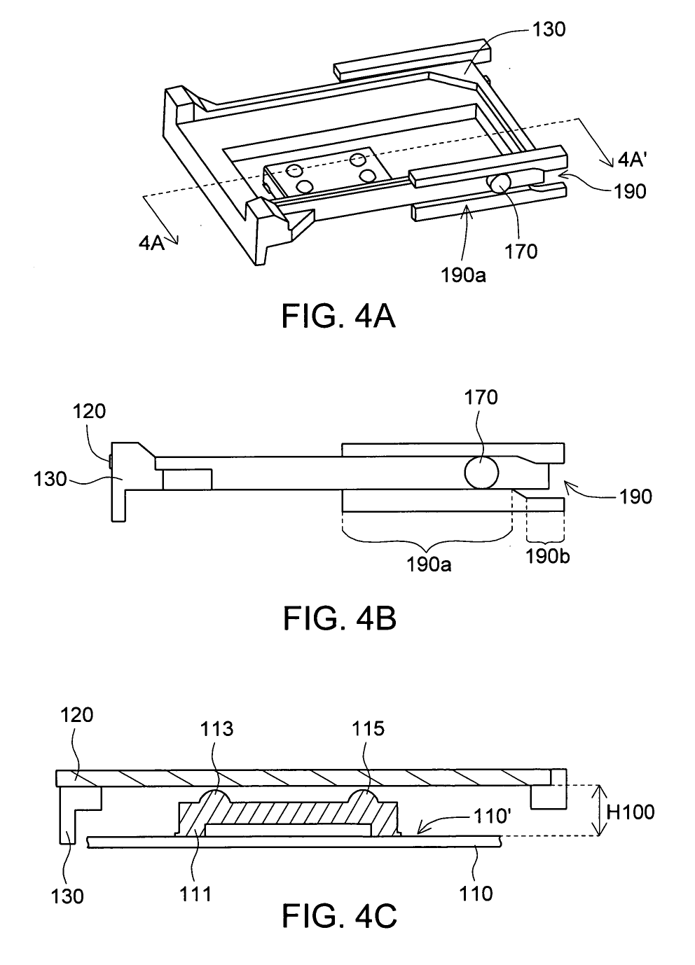

Referring to FIGS. 4A˜4C. FIGS. 4A and 4B show two perspectives of the first protrusion of FIG. 3 being located on a first regain track. FIG. 4C shows a cross-sectional view of the information storage card and metallic points of FIG. 4A along a cross-sectional line 4A-4A′. The first slide 190 is a cut-out slide. The first protrusion 170 of the containing element 130 is contained in and tightly slides on the cut-out slide. As indicated in FIG. 4C, when the first protrusion 170 is located on the first regain track 190a, the gap between the information storage card 120 and the surface 110′ is denoted by H100, and the gap between the apex of the metallic points 113 and 115 and the surface 110′ is smaller than the gap H100. Meanwhile, the information storage card 120 does not contact the metallic points 113 and 115. Thus, during installing the information storage card 120, when the first protrusion 170 is located on the first regain track 190a, the information storage card 120 does not compress the metallic points 113 and 115.

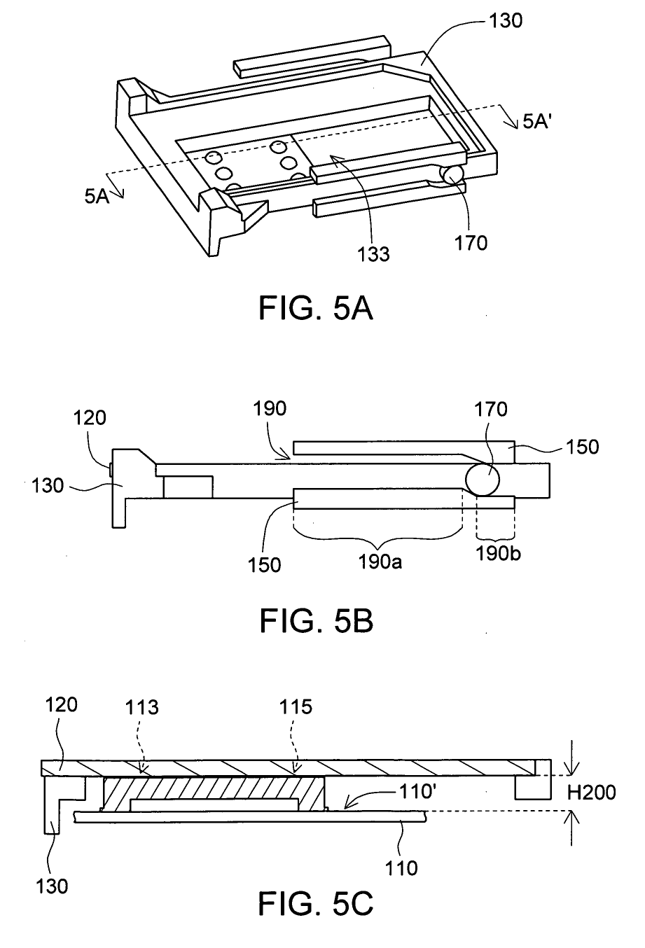

Referring to FIGS. 5A˜5C. FIGS. 5A and 5B show two perspective of the first protrusion of FIG. 3 being located on a second regain track. FIG. 5C shows a cross-sectional view of the information storage card and metallic points of FIG. 5A along a cross-sectional line 5A-5A′. When the first protrusion 170 of the containing element 130 is located on the second regain track 190b, the gap between the information storage card 120 and the surface 110′ is denoted by H200 and the information storage card 120 is electrically connected to the metallic points 113 and 115 via the opening 133 (not illustrated in FIG. 5C), wherein the gap H200 is smaller than the gap H100. Meanwhile, the information storage card 120 compresses the metallic points 113 and 115 to assure that the information storage card 120 is electrically connected to the metallic points 113 and 115.

Also, as indicated in FIG. 3, the information storage card holding structure of the electric device 100 further includes a second protrusion 171 and a second slide 191, wherein the second protrusion 171 is coupled to the second slide 191. The second protrusion 171 is disposed on the containing element 130, and the second slide 191 is disposed on the crutch 151 for example. The second slide 191 has a third regain track 191a and a fourth regain track 191b. The third regain track 191a is opposite to the first regain track 190a, and the fourth regain track 191b is opposite to the second regain track 190b.

In addition, the second slide 191 can also be a cut-out slide. The second protrusion 171 is contained in and tightly slides on the cut-out slide.

The information storage card holding structure of the present embodiment of the invention has a protrusion and a slide having a first regain track and second regain track. During installing the information storage card, when the protrusion is located on the first regain track, the information storage card does not compress the metallic points. When the information storage card is installed to a predetermined position, that is, when the protrusion is located on the second regain track, the information storage card tightly compresses the metallic points such that the information storage card is electrically connected to the electric device. Thus, the present embodiment of the invention prevents the information storage card from damaging the metallic points or being dead-locked during the installation process.

### Second Embodiment

According to the information storage card holding structure of the second embodiment of the invention, when the first protrusion is located on the second regain track, a blocker of the containing element is contained in the first regain track. As for other elements of the electric device similar to the above embodiment, the same designations are used and the details are not repeated here.

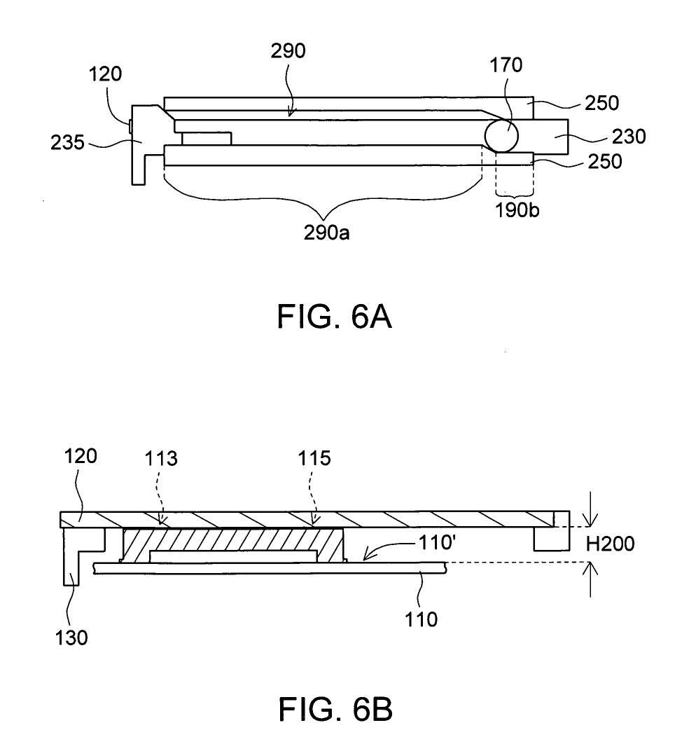

Referring to FIG. 6A and 6B. FIG. 6A shows a perspective of a first protrusion being located on a second regain track according to a second embodiment of the invention. FIG. 6B shows a cross-sectional view of FIG. 6A. The information storage card holding structure includes a blocker 235 disposed on the containing element 230. The first slide 290 is disposed on the crutch 250. The first slide 290 has a first regain track 290a and a second regain track 190b. When the first protrusion 170 is located on the second regain track 190b, the blocker 235 is located on the first regain track 290a and presses the crutch 250, and the containing element 230 is fixed on the crutch 250. Meanwhile, the containing element 230 and the information storage card 120 are substantially parallel to the surface 110′, and the information storage card 120 tightly compresses the metallic points 113 and 115.

With the blocker 235 being disposed on the containing element 230, it is assured that when the information storage card 120 compresses the metallic points 113 and 115, the blocker 235 presses the crutch 250 and makes the containing element 230 fixed and parallel to the surface 110′, such that the containing element 230 does not bounce back. As a result, the information storage card 120 tightly contacted the metallic points 113 and 115 is assure thus electrically connected to the metallic points 113 and 115.

According to the installation mechanism of the information storage card of the present embodiment of the invention, when the information storage card 120 is electrically connected to metallic points 113 and 115, with the first regain track 290a being pressed by the blocker 235, the containing element 230 and the information storage card 120 are parallel to the surface 110′ such that the metallic points 113 and 115 do not bounce back and that the information storage card 120 tightly contacts the metallic points for increasing the stability of the electric device.

### Third Embodiment

According to the information storage card holding structure of the third embodiment of the invention, the containing element further includes a third protrusion selectively is contained in a first regain track. As for other elements of the electric device similar to the above embodiment, the same designations are used and the details are not repeated here.

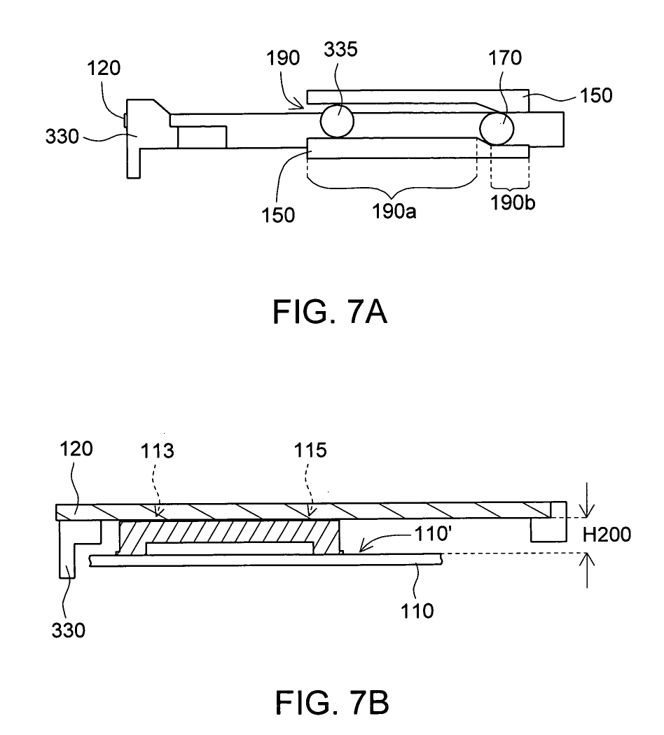

Referring to FIG. 7A and 7B. FIG. 7A shows a perspective of a first protrusion being located on a second regain track according to a third embodiment of the invention. FIG. 7B shows a cross-sectional view of FIG. 7A. The information storage card holding structure includes a third protrusion 335 disposed on the containing element 330. When the first protrusion 170 is located on the second regain track 190b, the third protrusion 335 is located on the first regain track 190a and presses the crutch 150, and the containing element 330 is fixed on the crutch 150 via the third protrusion 335. Meanwhile, the containing element 330 and the information storage card 120 are substantially parallel to the surface 110′, and the information storage card 120 tightly compresses the metallic points 113 and 115.

In the present embodiment of the invention, the third protrusion 335 presses the first regain track 190a. However, such arrangement is not for limiting the scope of the invention. When the first protrusion 170 is located on the second regain track 190b, the third protrusion 335 can be engaged in other regions of the electric device to make the information storage card tightly contact the metallic points. Any designs using an object to prevent the metallic points from being bounced back when the information storage card is electrically connected to the metallic points are within the scope of protection of the invention.

### Fourth Embodiment

In the information storage card holding structure of the fourth embodiment of the invention, the first protrusion is disposed on the crutch and the first slide is disposed on the containing element. As for other elements similar to the above embodiment, the same designations are used and the details are not repeated here.

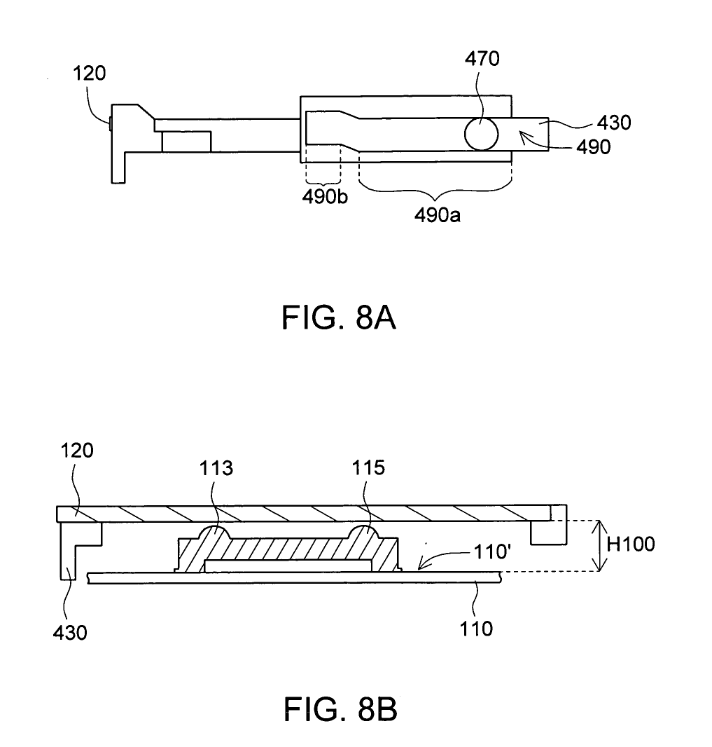

Referring to FIG. 8A, a perspective of a first protrusion being located on a first regain track according to a fourth embodiment of the invention is shown. The first protrusion 470 is disposed on a crutch (not illustrated), and the first slide 490 is disposed on the containing element 430, wherein the first slide 490 has a first regain track 490a and a second regain track 490b, and the first protrusion 470 is coupled to the first slide 490. The first slide 490 is for guiding the containing element 430 to move relatively to the first protrusion 470 of the crutch.

The first slide 490 of the present embodiment of the invention is disposed on the containing element 430. When the containing element 430 is moved, the first slide 490 is moved synchronously such that the first protrusion 470 slides relatively to the first slide 490. Thus, when the containing element 430 is moved, the first protrusion 470 can be selectively located on the first regain track 490a or the second regain track 490b of the first slide 490. Also, referring to FIGS. 8A and 8B. FIG. 8B shows a cross-sectional view of FIG. 8A. When the first protrusion 470 is located on the first regain track 490a, the information storage card 120 has the gap H100 to the surface 110′. Meanwhile, the information storage card 120 does not contact the metallic points 113 and 115.

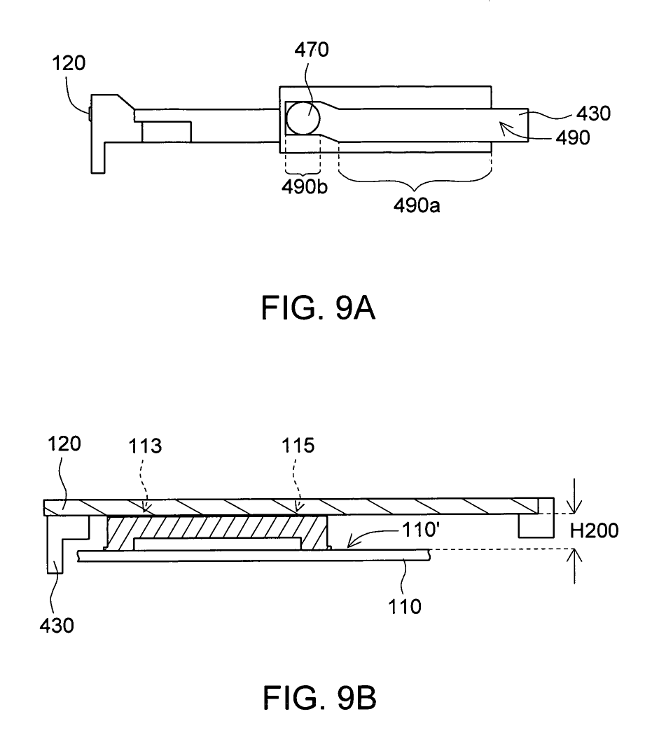

Referring to FIG. 9A and 9B. FIG. 9A shows a perspective of a first protrusion being located on a second regain track according to a fourth embodiment of the invention. FIG. 9B shows a cross-sectional view of FIG. 9A. When the first protrusion 470 is located on the second regain track 490b, the metallic points 113 and 115 have the gap H200 to the surface 110′, and the information storage card 120 is electrically connected to the metallic points 113 and 115. Meanwhile, the information storage card 120 compresses the metallic points 113 and 115 to assure that the information storage card 120 is electrically connected to the metallic points 113 and 115.

The above embodiments of the invention are not for limiting the scope of the invention. Anyone who is skilled in the technology of the invention will understand that there is no restriction regarding the position and number of the protrusion and the slide. Any designs in which the slide has a first regain track and a second regain track such that the information storage card can slide on the slide and selectively contact the metallic points via the protrusion are within the scope of the invention.

The information storage card holding structure disclosed in the above embodiments of the invention can be used in an electric device having an information storage card. The information storage card can be a flash memory card of a digital camera or a subscriber identity module (SIM) card of an electric device for telecommunication. As the slide provides two regain tracks and the protrusion slides relatively to the slide, the information storage card can selectively contact the metallic points of the electric device so that the metallic points will not be damaged by an external force during the installing the information storage card. The invention improves the reliability of electric device and prolongs its lifespan as well. Besides, the invention also effectively prevents the conventional information storage card from being dead-locked with the metallic points and makes the information storage card easy to be installed.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An information storage card holding structure making an information storage card selectively electrically connected to a plurality of metallic points that are placed on a surface of a circuit board, wherein the holding structure comprises:
a containing element for containing the information storage card;
a crutch for supporting the containing element;
a first protrusion; and
a first slide coupled to the first protrusion, wherein the first protrusion is disposed on one of the containing element and the crutch and the first slide is disposed on the other of the two elements, the first slide is for guiding the containing element to move relatively to the crutch, the first slide has a first regain track and a second regain track, when the first protrusion is located on the first regain track, the information storage card has a first gap to the surface, and when the first protrusion is located on the second regain track, the information storage card has a second gap to the surface and the information storage card is electrically connected to the metallic points, the second gap is smaller than the first gap.

2. The holding structure according to claim 1, further comprising a second slide and a second protrusion coupled to the second slide, wherein the second protrusion is disposed on one of the containing element and the crutch and the second slide is disposed on the other of the two elements, the second slide has a third regain track and a fourth regain track, the third regain track is opposite to the first regain track, and the fourth regain track is opposite to the second regain track.

3. The holding structure according to claim 1, wherein the first slide is a cut-out slide, and the first protrusion is contained in and tightly slides on the cut-out slide.

4. The holding structure according to claim 1, wherein the metallic points are a plurality of metallic elastic pieces, and when the first protrusion is located on the first regain track, the information storage card does not contact the metallic elastic pieces.

5. The holding structure according to claim 4, wherein the first protrusion is disposed on the containing element, the first slide is disposed on the crutch, and the holding structure further comprises:
a third protrusion disposed on the containing element, wherein when the third protrusion is coupled to the first slide, the information storage card is substantially parallel to the surface, and the information storage card compresses the metallic points.

6. The holding structure according to claim 4, the first protrusion is disposed on the containing element, the first slide is disposed on the crutch, and the holding structure further comprises:
a blocker disposed on the containing element, wherein when the blocker presses the first slide, the containing element is fixed on the crutch, the information storage card is substantially parallel to the surface, and the information storage card compresses the metallic points.

7. The holding structure according to claim 1, wherein the containing element is a containing platform whose bottom has an opening via which the information storage card is selectively electrically connected to the metallic points.

8. The holding structure according to claim 1, wherein the information storage card is a subscriber identity module (SIM) card.

9. The holding structure according to claim 1, wherein the information storage card is a flash memory card.

10. An electric device, comprising:
a circuit board having a surface; and
an information storage card holding structure for making an information storage card selectively electrically connected to a plurality of metallic points that are placed on the surface of the circuit board, wherein the holding structure comprises:
a containing element for containing the information storage card;
a crutch for supporting the containing element;
a first protrusion; and
a first slide coupled to the first protrusion, wherein the first protrusion is disposed on one of the containing element and the crutch and the first slide is disposed on the other of the two elements, the first slide is for guiding the containing element to move relatively to the crutch, the first slide has a first regain track and a second regain track, when the first protrusion is located on the first regain track, the information storage card has a first gap to the surface, and when the first protrusion is located on the second regain track, the information storage card has a second gap the surface and the information storage card is electrically connected to the metallic points, the second gap is smaller than the first gap.

11. The electric device according to claim 10, wherein the holding structure further comprising a second slide and a second protrusion coupled to the second slide, wherein the second protrusion is disposed on one of the containing element and the crutch and the second slide is disposed on the other of the two elements, the second slide has a third regain track and a fourth regain track, the third regain track is opposite to the first regain track, and the fourth regain track is opposite to the second regain track.

12. The electric device according to claim 10, wherein the first slide is a cut-out slide, and the first protrusion is contained in and tightly slides on the cut-out slide.

13. The electric device according to claim 10, wherein the metallic points are a plurality of metallic elastic pieces, and when the first protrusion is located on the first regain track, the information storage card does not contact the metallic elastic pieces.

14. The electric device according to claim 13, wherein the first protrusion is disposed on the containing element, the first slide is disposed on the crutch, and the holding structure further comprises:
a third protrusion disposed on the containing element, wherein when the third protrusion is coupled to the first slide, the information storage card is substantially parallel to the surface, and the information storage card compresses the metallic points.

15. The electric device according to claim 13, wherein the first protrusion is disposed on the containing element, the first slide is disposed on the crutch, and the holding structure further comprises:
a blocker disposed on the containing element, wherein when the blocker presses the first slide, the containing element is fixed on the crutch, the information storage card is substantially parallel to the surface, and the information storage card compresses the metallic points.

16. The electric device according to claim 10, wherein the containing element is a containing platform whose bottom has an opening via which the information storage card is selectively electrically connected to the metallic points.

17. The electric device according to claim 10, wherein the information storage card is a subscriber identity module (SIM) card.

18. The electric device according to claim 10, wherein the information storage card is a flash memory card.
